(19) United States
(12) Patent Application Publication
(10) Pub. No.: US 2013/0283916 A1
(43) Pub. Date: Oct. 31, 2013

(54) SELF-TESTING FUNCTIONAL CHARACTERISTICS OF ULTRASONIC SENSORS

(71) Applicants: Stephen Hersey, Waltham, MA (US); Michael Sussman, Winchester, MA (US)

(72) Inventors: Stephen Hersey, Waltham, MA (US); Michael Sussman, Winchester, MA (US)

(21) Appl. No.: 13/456,879

(22) Filed: Apr. 26, 2012

(51) Int. Cl. G01N 29/14

(52) U.S. Cl. 73/587

(57) ABSTRACT

Functional characteristics of an ultrasonic element are self-tested by, in various embodiments, causing the ultrasonic element to emit an ultrasonic signal; detecting the emitted ultrasonic signal substantially simultaneously with its emission; and verifying proper operation of the ultrasonic element based on comparison between a detected ultrasonic signal parameter and a reference parameter.

### FIELD OF THE INVENTION

In various embodiments, the present invention relates generally to ultrasonic sensors, and in particular to verifying sensor functionality.

### BACKGROUND

Ultrasonic probes and systems, like other complex electronic devices, may develop faults with extended use and wear. For example, the channels of ultrasound systems that detect object movement and location may malfunction due to power fluctuations, component aging or disconnection, or other electrical hazards. Although these faults and failures are typically manifestly apparent (e.g., the probe or system will simply fail completely), some problems, such as the failure of a single channel in a multichannel system, are more subtle and may not be immediately recognized by a user. Such undetected failures can lead to degradation in ultrasonic performance that is difficult to remedy and, in more severe cases, failed detection of objects without warning—a significant safety hazard in industrial applications.

Conventionally, testing and verifying the functional characteristics (e.g., operational capability) of ultrasonic detection systems involves an inspection system that requires extra mechanical components (e.g., test targets) and/or electronic circuitry. For example, a diagnostic processor and its associated circuitry may be used to command, on a channel-by-channel basis, the ultrasound beamformer to sequentially pulse each individual transducer element and to analyze the received echoes from the probe-air interface. Alternatively, test targets may be placed in front of the probes during the system diagnosis; the reflected echoes received by each channel are then analyzed to determine the functionality of the sensors. The extra components and set-up time in these approaches can be cumbersome and increase system weight, cost and complexity.

Another testing approach is to manually assess the performance of the ultrasound system. For example, the operator may place one or more test targets in a field of view of the ultrasound system and ensure that those test targets are all detected by the system. The operator examines the characteristics of not only the new transducer elements, but also the previously used transducer elements and records the results frequently; such examination and recordation is time consuming and quickly becomes a large burden for the operator. Additionally, degradation of functional characteristics may be difficult to identify at an early stage, requiring the expertise of a trained operator.

Consequently, there is a need for an ultrasound system that can self-test and verify its functionality without manual intervention or extraneous components.

### SUMMARY

In various embodiments, the present invention relates to systems and methods for self-testing and self-diagnosing the functional characteristics of ultrasound sensors using characteristics of the response profile of an ultrasonic transducer operating as a receiver. In particular, it is found that the response profile includes a rising phase, a saturated phase and a decay phase. The response profile of a detection channel under test are compared with a reference response profile. Sufficient deviation from the reference profile indicates a malfunctioning detection channel, and the nature of the deviation may be used to diagnose a particular malfunction. In some embodiments, for example, the deviation indicates sensor aging, in which case the ultrasonic controller can adjust the drive signal or other transmission parameters to compensate. The response profile is highly repeatable and predictable, and can be obtained and analyzed quickly and frequently without adding extra components to the system; the current invention thus provides an approach to verifying the functional characteristics of an ultrasonic detection system accurately and reliably without manual testing or the need for dedicated testing components.

Accordingly, in one aspect, the invention pertains to a method of self-testing functional characteristics of an ultrasonic element. In various embodiments, the method includes causing the ultrasonic element to emit an ultrasonic signal, detecting the emitted ultrasonic signal substantially simultaneously with its emission, and verifying proper operation of the ultrasonic element based on comparison between a detected ultrasonic signal parameter and a reference parameter. The ultrasonic element may be the transducer of a ranging or tracking device, and the signal may be detected prior to receiving a reflected signal.

The ultrasonic element may be one of multiple ultrasonic elements and the reference parameter may be an average of multiple signal parameters each associated with one of the ultrasonic elements in proper operation. In one embodiment, the signal parameter includes a signal characteristic and the reference parameter includes a reference characteristic. In one implementation, the reference characteristic includes a rising phase amplitude, a saturated phase amplitude, and a decreasing phase amplitude. In another embodiment the signal parameter is a signal amplitude and the reference parameter is a reference amplitude threshold. In various embodiments, the signal parameter is a time period during which an amplitude of the signal is larger than a voltage threshold and the reference parameter is a reference minimum time period.

In a second aspect, the invention relates to a system for self-testing an ultrasonic transducer element using a detector element for receiving ultrasonic signals emitted by the transducer element. In various embodiments, the system includes drive circuitry coupled to the transducer element for causing the transducer element to emit ultrasonic signals and a controller for controlling ultrasonic-signal emission and detection by the transducer element and the detector element, respectively. The controller may be configured to verify proper operation of the transducer element based on comparison between a detected ultrasonic signal parameter and a reference parameter. In a ranging or tracking device, the ultrasonic signal may be detected prior to receiving a reflected signal. In one embodiment, the transducer element both emits and receives the ultrasonic signals. In another embodiment, the ultrasonic element is one of multiple ultrasonic elements and the drive circuitry causes a first transducer element to emit the ultrasonic signals and a second transducer element to detect the emitted ultrasonic signals.

In one embodiment, the signal parameter includes a signal characteristic and the reference parameter includes a reference characteristic. In one implementation, the reference characteristic includes a rising phase amplitude, a saturated phase amplitude, and a decreasing phase amplitude. In another embodiment, the signal parameter is a signal amplitude and the reference parameter is a reference amplitude threshold. In some embodiments, the signal parameter is a time period during which an amplitude of the signal is larger than a voltage threshold and the reference parameter is a reference minimum time period.

As used herein, the terms “substantially” and “approximately” mean ±10%, and in some embodiments, ±5%. Reference throughout this specification to “one example,” “an example,” “one embodiment,” or “an embodiment” means that a particular feature, structure, or characteristic described in connection with the example is included in at least one example of the present technology. Thus, the occurrences of the phrases “in one example,” “in an example,” “one embodiment,” or “an embodiment” in various places throughout this specification are not necessarily all referring to the same example. Furthermore, the particular features, structures, routines, steps, or characteristics may be combined in any suitable manner in one or more examples of the technology. The headings provided herein are for convenience only and are not intended to limit or interpret the scope or meaning of the claimed technology.

### BRIEF DESCRIPTION OF THE DRAWINGS

In the drawings, like reference characters generally refer to the same parts throughout the different views. Also, the drawings are not necessarily to scale, with an emphasis instead generally being placed upon illustrating the principles of the invention. In the following description, various embodiments of the present invention are described with reference to the following drawings, in which:

FIG. 1 schematically depicts an exemplary ultrasound transducer system;

FIG. 2 illustrates the response of a properly operating ultrasound sensor to a transmitted ultrasound pulse; and

FIGS. 3A-3J depicts determining the malfunction of the transducer elements and/or other ultrasonic components based on the measured data and a reference set of response characteristics.

### DETAILED DESCRIPTION

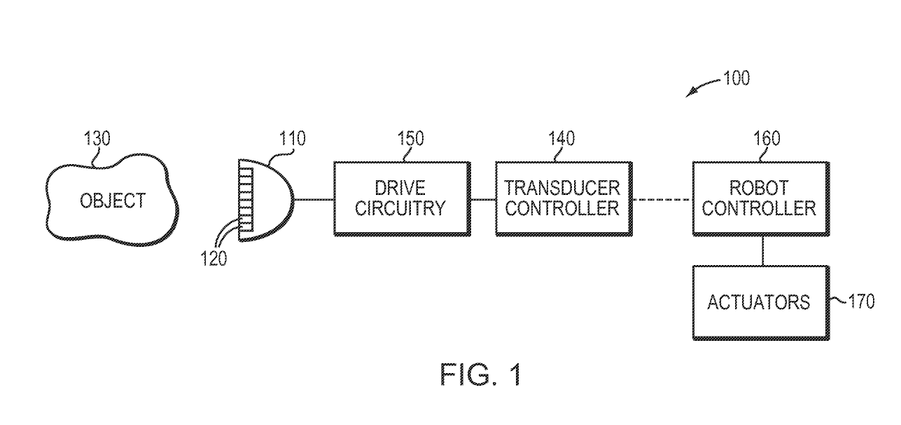

FIG. 1 depicts an exemplary ultrasound transducer system 100 to which embodiments of the present invention may be applied, although alternative systems with similar functionality are also within the scope of the invention. As depicted, an ultrasound transducer 110 includes multiple transducer elements 120. Each transducer element 120 emits directional ultrasound signals towards objects 130, e.g., humans or equipment, and/or receives the reflected signals therefrom. In various embodiments, each transducer 120 acts as both a transmitter and receiver. A transducer controller 140 regulates several aspects of the emitted ultrasound signals, e.g., frequency, phase, and amplitude, by controlling the transducer elements via the associated drive circuitry 150 (which sends signals to the transducer elements 120). In addition, the controller 140 analyzes the reflected signals and determines the functional characteristics of the transducer element 120 based thereon as described in greater detail below.

Each transducer element 120 may be associated with a separate controller 140 and/or drive circuitry 150, in which case the controllers 140 and drive circuitry 150 may use identical signal-processing circuits and have the same electrical characteristics. Alternatively, some or all of the transducer elements 120 may be regulated by a single controller 140 and drive circuitry 150. In one embodiment, each transducer element 120 both emits and receives the ultrasonic signals. In another embodiment, the ultrasound system is a multichannel system in which signals are emitted by some transducer elements 120 and received by other transducer elements 120; see, e.g., U.S. Ser. No. 13/243,253, filed on Sep. 23, 2011, the entire disclosure of which is hereby incorporated by reference.

In various embodiments the controller 140 is provided as either software, hardware, or some combination thereof. For example, the system may be implemented on one or more server-class computers, such as a PC having a CPU board containing one or more processors such as the Core Pentium or Celeron family of processors manufactured by Intel Corporation of Santa Clara, Calif. and POWER PC family of processors manufactured by Motorola Corporation of Schaumburg, Ill., and/or the ATHLON line of processors manufactured by Advanced Micro Devices, Inc., of Sunnyvale, Calif. The controller 140 may contain a processor that includes a main memory unit for storing programs and/or data relating to the methods described above. The memory may include random-access memory (RAM), read-only memory (ROM), and/or FLASH memory residing on commonly available hardware such as one or more application-specific integrated circuits (ASIC), field-programmable gate arrays (FPGA), electrically erasable programmable read-only memories (EEPROM), programmable read-only memories (PROM), or programmable logic devices (PLD). In some embodiments, the programs are provided using external RAM and/or ROM such as optical disks, magnetic disks, as well as other commonly used storage devices.

For embodiments in which the controller 140 is provided as a software program, the program may be written in any one of a number of high level languages such as FORTRAN, PASCAL, JAVA, C, C++, C#, LISP, PERL, BASIC, PYTHON or any suitable programming language. Additionally, the software can be implemented in an assembly language and/or machine language directed to the microprocessor resident on a target device.

The illustrated ultrasound system 100 may advantageously be deployed in an industrial robot. In general, an industrial robot is an automatically controlled, reprogrammable, multipurpose manipulator. Most robots include robotic arms and/or manipulators that operate within a working envelope, and whose movements are driven by actuators operated by a robot controller; see, e.g., U.S. Pat. No. 5,650,704 and U.S. Ser. No. 12/843,540, filed on Jul. 26, 2010, and Ser. No. 13/159,047, filed on Jun. 13, 2011, the entire disclosures of which are hereby incorporated by reference. Thus, as illustrated, a robot controller 160 may be employed to control the kinematics of a robot, including movements of manipulators and appendages, by signals sent to actuators 170 in a manner well-known to those skilled in the art. Here, the robot controller 160 is responsive to signals from transducer controller 140. For example, when the transducer controller 140 detects a malfunctioning sensor, it signals robot controller 160 which, in turn, disables all of the relevant actuators 170 whose operation might cause harm to the detected object. Of course, the controllers 140, 160 need not be separate entities, but may instead be implemented within a single overall system controller.

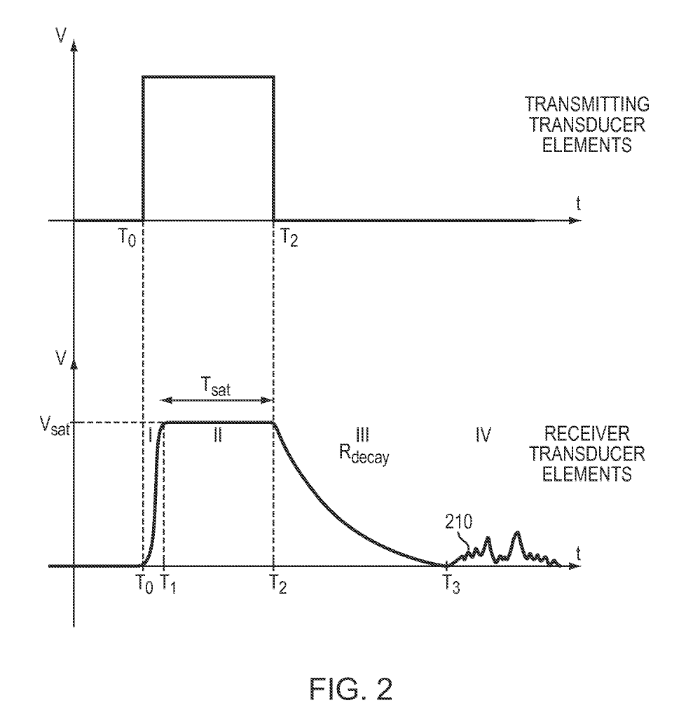

Referring to FIG. 2, during the self-testing or self-diagnostic process, the transmitting transducer elements are first excited from time T₀ to time T₂. The ultrasonic transducer is a mechanically resonant system; when driven electrically at its resonant frequency, it vibrates mechanically, and in so doing, stores energy in its vibrating (ringing) mass. In various embodiments, the drive circuitry 150 excites the transmitting transducer elements 120, i.e., applies a drive signal to them, causing them to emit ultrasound signals. Although the illustrated transducer drive signal is a square wave, the output is not, because the transducer is a resonant mechanical circuit with a fairly high Q. The output will have characteristic rise and fall (decay, ringdown) times determined by the transducer and the size of the drive signal. When the drive signal ends at T₂, its acoustic (and electrical) oscillation takes some time to decay as the stored energy is emitted. This is known as the “ring-down” process.

The emitted ultrasound signals are received by receiver channels of the transducer elements 120, which may or may not be the transmitting transducer elements, and amplified by an inverting amplifier before being processed. The receiver is designed to detect very faint signals resulting from sound echoes. The receiver output is essentially proportional to the envelope of the amplitude of the electrical signal at the terminals of the transducer. When drive signals are first applied to the transmitting transducers, the large transmit signal immediately saturates the sensitive receiver, which causes the sharp rise to a saturation condition. As long as the transducer is being driven, the receiver remains saturated. When the drive signal ends, it takes some time for a transmitting transducer's electrical output signal to decay (ring down) to an amplitude small enough that it no longer saturates the receiver. From that point on, the receiver output follows an exponential decay curve, until the first echo is received by the transducer. At that point, “bumps” appear in the amplifier output due to the received echoes.

More specifically, as shown in FIG. 2, the received signal output by the inverting amplifier of the receiver channels are characterized by four distinct phases I-IV that collectively constitute the response profile. In the first phase, the amplifier output rises rapidly beginning at time T₀, reaching a saturated value, Vₛₐₜ, at time T₁>T₀. In the second (saturated) phase, the amplifier output in the receiver channels remains saturated from time T₁ to time T₂, i.e., as long as the transmitters are active. The saturation time in phase 2 is defined as Tₛₐₜ=T₂−T₁. The saturation voltage amplitude, Vₛₐₜ, and the saturation time, Tₛₐₜ, of the amplifier output are constant for a properly operating transducer element. Phase II ends when the transmitter drive signal terminates. In a third (decay) phase, the receiver amplifier output gradually decays to a baseline value at time T₃ due to the decreased output voltage of the transmitting transducer elements. The amplifier output maintains the baseline value until the first ultrasonic echoes 210 reflected from objects are received. In a fourth (object detection) phase, the echoes are received, and the amplifier output rises from the baseline value. The time dependence of the amplifier output in the object detection phase is determined by the presence and location of objects in the field of view and therefore is unpredictable.

The receiver output profile—particularly the saturation and decay phases (i.e., phases II and III), including the exponential ringdown of the transducer—are determined by the electrical/mechanical/sonic properties of the overall system. Accordingly, if a transducer element is properly operating, phases I-III of the response profile are highly repeatable and therefore predictable. (As used herein, the term “proper operation” means that a transducer element is capable of delivering maximum allowable power to the target and/or detecting a minimum detectable signal from the target; and in the remainder of this discussion, the “response profile” refers to phases I-III of the receiver signal.) A reference response profile characteristic of a properly operating receiver is obtained prior to the self-testing procedure, and the measured data during the self-testing procedure is compared with the reference profile If measured variations from the reference profile lie within a tolerance range or signal envelope that is determined, for example, by the manufacturing or application tolerances of the components used, the test data is considered normal and the transducer element is determined to be in proper operation. If a significant deviation from the tolerance range or signal envelope is observed (i.e., the variations are beyond the tolerance range or signal envelope), a malfunction in the receiver channel is indicated. It should be noted that the saturation voltage, Vₛₐₜ, may be lower and the saturation time, Tₛₐₜ, may be shorter if the detection system uses separate transmitting and receiving transducer elements rather than using the same transducer element to transmit and receive signals. The response profile, however, is still repeatable and predictable in each system and may be suitable for self-testing or self-diagnosing purposes.

During a self-testing procedure, the signal generated by the transducer element under test is compared with the reference profile using a simple difference calculation or a conventional curve-fitting technique. If the deviation of the measured curve is small (e.g., within 5% or 10% averaged over the entire reference profile), the tested ultrasound transducer element is considered to be properly operating. In one embodiment, a multichannel system that uses identical channel configurations is tested, where amplifier output data averaged over multiple channels is used as the reference response profile. In the multichannel system, however, a common defect may affect every transducer element. Consequently, using this self-testing approach may not effectively detect the transducer malfunction; other approaches may be necessary in combination with the self-testing approach described herein.

In some embodiments, the reference profile is defined by critical points on the curve, e.g., one or more of the maximum and minimum thresholds of, for example, the saturation voltage, Vₛₐₜ, the saturation time, Tₛₐₜ, the decay rate, R_{decay}, the maximum baseline voltage in phase 3, and/or an average value of the received amplifier output in phases I, II, and III. The reference set of thresholds can be used to quickly check the functional characteristics of each transducer element. If the transducer element passes all the threshold tests, it is considered to be properly operating. If one or more measured amplifier output data points falls outside the thresholds, it indicates the transducer element may be malfunctioning or will malfunction in the near future. A more detailed testing procedure comparing the response profile with a reference curve may be performed to identify the particular type of transducer element malfunction.

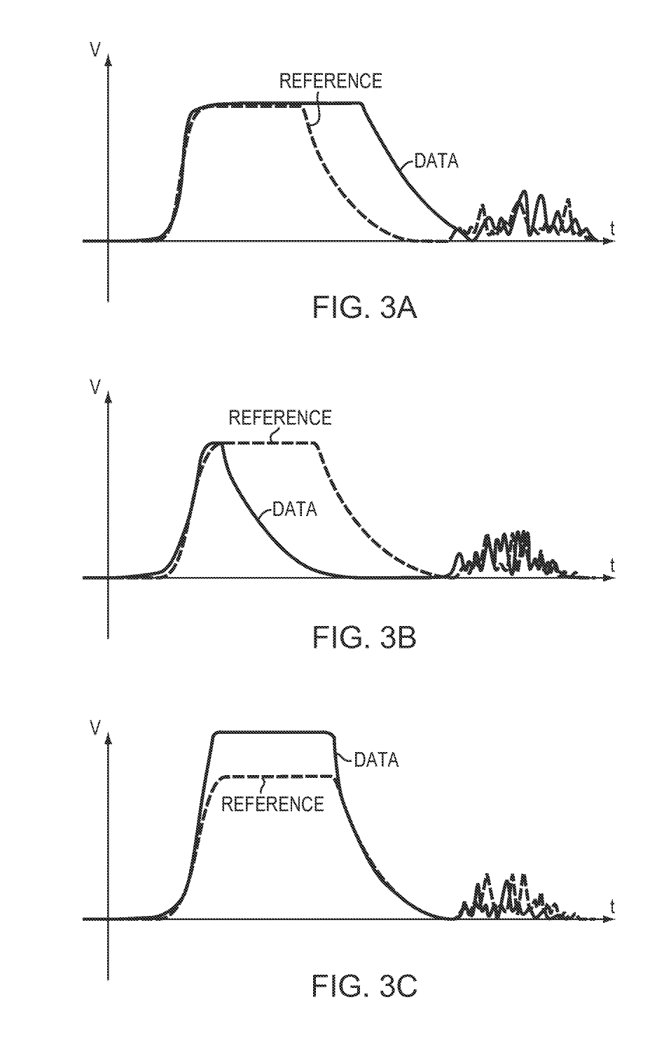

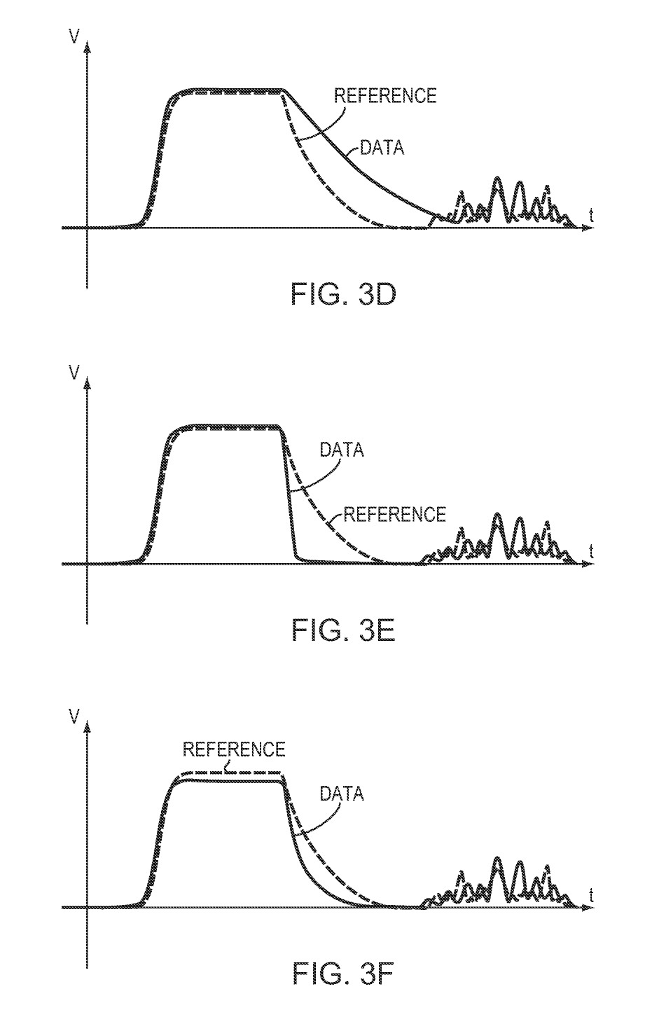

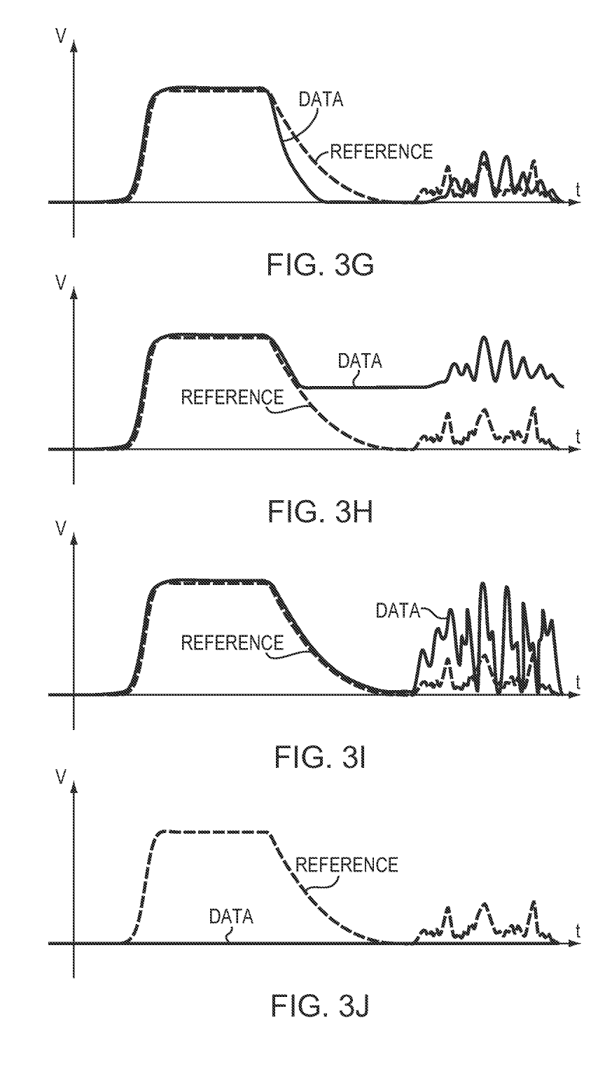

Particular deviations from a reference profile or reference thresholds may be associated with specific malfunctions. Additionally, deviations from the reference profile may be used to initially identify malfunctions of other components in the ultrasound system. As described above, the saturation voltage amplitude, Vₛₐₜ, and the saturation time, Tₛₐₜ, of the amplifier output are constant for a properly operating transducer element. If an increased (e.g., by more than 20%) saturation time is observed, as depicted in FIG. 3A, the receiver transducer element may be obstructed by an object positioned in front of it such that the stored mechanical energy is trapped inside the transducer element and cannot dissipate promptly upon a decrease in the transmitting voltage. As described below, for most signal parameters a deviation of 10% is generally indicative of an abnormality; the variation in saturation time may be wider than this (i.e., 20%) because the ultrasonic transducers tend to have a wider range of normal variation than other electronic components. If, however, a significantly decreased (e.g., by more than 10%) saturation time is detected, as depicted in FIG. 3B, the receiver channel may be missing, disconnected, or open-circuited such that no mechanical energy is stored in the receiver transducer element.

If the saturation voltage is abnormally (e.g., more than 10%) high, as depicted in FIG. 3C, an excessive gain is likely present in the analog signal-processing chain. Referring to FIG. 3D, if a transducer element is covered by dust, the saturation voltage and time duration may be normal; the decay rate, however, will be significantly (e.g., more than 10%) slower than the standard value for a properly operating element; this is because the voltage decay is interrupted by signals reflected from the occluding dust.

If a transducer element is damaged, a rapid decay rate may be observed, as depicted in FIG. 3E. In a situation where a transducer element and/or other components are aging, the transducer element may not be able to emit an energy as large and/or as long as required by the controller; this results in a lower value of the saturation amplitude Vₛₐₜ and/or shorter saturation time Tₛₐₜ and a faster decay rate, as depicted in FIGS. 3F and 3G.

Referring to FIG. 3H, an amplifier output decaying to an intermediate value above a standard baseline value upon the transmitting voltage decreasing indicates (i) that the receiver transducer element is disconnected or open-circuited; (ii) a component failure in the analog signal processing chain; and/or (iii) an incorrect voltage being supplied. In the case of electrical interference, the presence of undesired objects near the transducer elements, or faulty signal grounds in the analog signal processing chain, the amplifier output signal may show abnormally large variations after decaying to the baseline voltage, as depicted in FIG. 3I. If a flat-line amplifier output is observed (FIG. 3J), there may be an open circuit in the analog signal processing chain.

In some embodiments, upon detecting a deviation of the amplifier output characteristics, the controller 140 causes display of an error code corresponding to the diagnosed malfunction. This self-diagnosis thus advantageously offers convenient troubleshooting for the operator. In addition, particularly in situations where harm to humans is possible, the self-diagnosis may trigger a repair alarm, directing the operator and/or a repair procedure to fix the detected malfunction. Finally, the controller 140 may take steps automatically to compensate for the diagnosed condition. For example, when the deviation indicates that components are drifting or aging, the controller may increase the amplitude and/or duration of the transducer excitation, adjust the amplifier gain, and/or the echo detection thresholds to compensate for the drifting and aging. Coefficients corresponding to compensation factors may be stored in nonvolatile memory as a “pedigree” for the affected transducer element(s) and used by the controller and/or drive circuitry whenever the element(s) is/are activated.

The terms and expressions employed herein are used as terms and expressions of description and not of limitation, and there is no intention, in the use of such terms and expressions, of excluding any equivalents of the features shown and described or portions thereof In addition, having described certain embodiments of the invention, it will be apparent to those of ordinary skill in the art that other embodiments incorporating the concepts disclosed herein may be used without departing from the spirit and scope of the invention. Accordingly, the described embodiments are to be considered in all respects as only illustrative and not restrictive.

What is claimed is:

1. A method of self-testing functional characteristics of an ultrasonic element, the method comprising:
causing the ultrasonic element to emit an ultrasonic signal;
detecting the emitted ultrasonic signal substantially simultaneously with its emission; and
verifying proper operation of the ultrasonic element based on comparison between a detected ultrasonic signal parameter and a reference parameter.

2. The method of claim 1, wherein (i) the ultrasonic element is one of a plurality of ultrasonic elements and (ii) the reference parameter is an average of a plurality of signal parameters each associated with one of the ultrasonic elements in proper operation.

3. The method of claim 1, wherein the signal parameter comprises a signal characteristic and the reference parameter comprises a reference characteristic.

4. The method of claim 3, wherein the reference characteristic comprises a rising phase amplitude, a saturated phase amplitude, and a decreasing phase amplitude.

5. The method of claim 1, wherein the signal parameter is a signal amplitude and the reference parameter is a reference amplitude threshold.

6. The method of claim 1, wherein the signal parameter is a time period during which an amplitude of the signal is larger than a voltage threshold and the reference parameter is a reference minimum time period.

7. The method of claim 1, wherein the ultrasonic signal is detected prior to receiving a reflected signal.

8. A system for self-testing an ultrasonic transducer element using a detector element for receiving ultrasonic signals emitted by the transducer element, the system comprising:
drive circuitry coupled to the transducer element for causing the transducer element to emit ultrasonic signals; and
a controller for controlling ultrasonic-signal emission and detection by the transducer element and the detector element, respectively, the controller being configured to verify proper operation of the transducer element based on comparison between a detected ultrasonic signal parameter and a reference parameter.

9. The system of claim 8, wherein the transducer element both emits and receives the ultrasonic signals.

10. The system of claim 8, wherein (i) the ultrasonic element is one of a plurality of ultrasonic elements and (ii) the drive circuitry causes a first transducer element to emit the ultrasonic signals and a second transducer element to detect the emitted ultrasonic signals.

11. The system of claim 8, wherein the signal parameter comprises a signal characteristic and the reference parameter comprises a reference characteristic.

12. The system of claim 11, wherein the reference characteristic comprises a rising phase amplitude, a saturated phase amplitude, and a decreasing phase amplitude.

13. The system of claim 8, wherein the signal parameter is a signal amplitude and the reference parameter is a reference amplitude threshold.

14. The system of claim 8, wherein the signal parameter is a time period during which an amplitude of the signal is larger than a voltage threshold and the reference parameter is a reference minimum time period.

15. The system of claim 8, wherein the ultrasonic signal is detected prior to receiving a reflected signal.
